(19) United States
(12) Patent Application Publication
(10) Pub. No.: US 2026/0249704 A1
(43) Pub. Date: Aug. 27, 2026

(54) Regenerative and Friction Braking for Electric Motorcycles

(71) Applicants: Indian Motorcycle International, LLC, Medina, MN (US); Polaris Industries Inc., Medina, MN (US)

(72) Inventors: Adam Quick, Burgdorf (CH); Benjamin Comana, Bern (CH)

(21) Appl. No.: 19/534,470

(22) Filed: Feb. 9, 2026

Related U.S. Application Data
(60) Provisional application No. 63/756,331, filed on Feb. 10, 2025.

(51) Int. Cl. B60L 7/26; B60L 3/10; B60L 58/15

(52) U.S. Cl. CPC B60L 7/26; B60L 3/108; B60L 58/15; B60L 2200/12; B60L 2240/54; B60L 2250/26

(57) ABSTRACT

A system for provided a braking torque to a wheel of an electric motorcycle, comprising: a hydraulic system and an electrical system each mechanically coupled to the wheel and coupled to a controller. The system senses an input to a brake control representing a torque demand. The controller calculates an available regenerative braking torque (“ARBT”) available from the electrical system, determines a boost torque required to meet the torque demand, responds to the ARBT being sufficient to provide the boost torque by causing the electrical system to apply a regenerative torque to the wheel corresponding to the boost torque, and responds to the ARBT being insufficient by causing the electrical system to apply the ARBT to the wheel and causing the hydraulic system to apply an increased friction braking torque corresponding to a difference between the boost torque and the ARBT.

### RELATED APPLICATIONS

This application claims the benefit of priority to U.S. Provisional Application Ser. No. 63/756,331, filed Feb. 10, 2025, the content of which is incorporated herein by reference in its entirety.

### BACKGROUND

For electric vehicles, the primary mover or electric machine in a regenerative braking mode of operation can be used to convert mechanical energy from the vehicle (i.e., rotation of an axle or wheel) into electrical energy which is stored in a battery system of the vehicle to extend the range of the vehicle. While regenerative control strategies have been implemented on electric motorcycles, such conventional strategies are not integrated with the mechanical braking system of the motorcycles.

### SUMMARY

In one embodiment, the present disclosure provides a system for providing a braking torque to a wheel of an electric motorcycle. The system includes a hydraulic system hydraulically coupled to a friction brake of the motorcycle, where the friction brake is mechanically coupled to the wheel and configured to decrease a rotation speed of the wheel in response to a pressure of hydraulic fluid provided to the friction brake by the hydraulic system. An electrical system is mechanically coupled to the wheel, a controller is coupled to the hydraulic system and the electrical system. The hydraulic system includes a sensor configured to detect an input received at a brake control of the hydraulic system, the input corresponding to a brake torque demand. The controller is configured to calculate, based on a status of a battery of the electrical system, an available regenerative braking torque available from the electrical system. The controller is further configured to determine a brake boost torque, the brake boost torque including a torque to provide in addition to a friction braking torque of the hydraulic system, to meet the brake torque demand. The controller is additionally configured to respond to the available regenerative braking torque being sufficient to provide the brake boost torque by causing the electrical system to apply a first regenerative torque to the wheel in an amount corresponding to the brake boost torque.

In one aspect of this embodiment, the controller is configured to respond to the available regenerative torque being insufficient to provide the brake boost torque by causing the electrical system to apply a second regenerative braking torque to the wheel in an amount corresponding to the available regenerative torque and causing the hydraulic system to apply an increased friction braking torque, in addition to the friction braking torque, in an amount corresponding to a difference between the brake boost torque and the second regenerative braking torque. In another aspect, the input is a force applied to the brake control and the sensor is a pressure sensor configured to sense a change in hydraulic pressure corresponding to the force applied to the brake control, the sensed hydraulic pressure corresponding to the brake torque demand. In a variant of this aspect, the controller is configured to determine the brake boost torque based on the sensed hydraulic pressure, by determining a difference between the brake torque demand and a friction braking torque available from the hydraulic system. In another aspect, the available regenerative braking torque is a maximum available braking torque. In another aspect, the electrical system includes a battery pack communicatively coupled to the controller, the battery pack including the battery and a battery management system configured to provide the controller the status of the battery including a charging current capacity of the battery. In yet another aspect, the controller is configured to cause the electrical system to apply the first regenerative torque to the wheel by commanding a motor controller of the electrical system to cause an electric machine mechanically coupled to the wheel to operate as a generator to convert mechanical energy of the wheel into electrical energy. In a variant of this aspect, the electric machine is configured to provide the electrical energy to a battery pack for storage in the battery. In another aspect, the controller is configured to cause the hydraulic system to apply the increased friction braking torque by commanding a hydraulic pressure generator and evacuator of the hydraulic system to increase the friction braking torque by an amount corresponding to the increased friction braking torque. In a variant of this aspect, the hydraulic pressure generator and evacuator is an ABS modulator of the hydraulic system. Tn a variant of this aspect, the hydraulic pressure generator and evacuator is a pressure booster.

In another embodiment the present disclosure provides a method for providing a braking torque to a wheel of an electric motorcycle. The method includes detecting an input received at a brake control of the motorcycle, where the input represents a brake torque demand. The method further includes determining a brake boost torque, where the brake boost torque includes a torque to provide in addition to a friction braking torque of a hydraulic system of the motorcycle, to meet the brake torque demand. The method additionally includes calculating, based on a status of a battery of an electrical system of the motorcycle, an available regenerative torque, and responding to the available regenerative torque being sufficient to provide the brake boost torque by causing the electrical system to apply a first regenerative torque to the wheel in an amount corresponding to the brake boost torque.

In one aspect of this embodiment, the method further comprises responding to the available regenerative torque being insufficient to provide the brake boost torque by causing the electrical system to apply a second regenerative braking torque to the wheel in an amount corresponding to the available regenerative torque and causing the hydraulic system to apply an increased friction braking torque, in addition to the friction braking torque, in an amount corresponding to a difference between the brake boost torque and the second regenerative braking torque. In another aspect, detecting an input includes sensing a force applied to the brake control using a pressure sensor configured to sense a change in hydraulic pressure corresponding to the force applied to the brake control, the sensed hydraulic pressure corresponding to the brake torque demand. In a variant of this aspect, detecting an input includes providing, by the pressure sensor, at least one measurement of the sensed hydraulic pressure to a controller in communication with the pressure sensor. In another variant, determining the brake boost torque includes determining, by a controller based on the sensed hydraulic pressure, a difference between the brake torque demand and a friction braking torque available from the hydraulic system. In another aspect, the available regenerative torque is a maximum available regenerative torque. In yet another aspect, determining the available regenerative braking torque includes receiving, by a controller, from a battery management system of a battery pack of the electrical system, a charging current capacity of the battery. In another aspect, causing the electrical system to apply the first regenerative torque to the wheel includes commanding, by a controller, a motor controller to cause an electric machine mechanically coupled to the wheel to operate as a generator to convert mechanical energy of the wheel into electrical energy. In a variant of this aspect, the method further comprises storing the electrical energy in the battery. In another aspect, causing the electrical system to apply the second regenerative torque to the wheel includes commanding, by a controller, a motor controller to cause an electric machine mechanically coupled to the wheel to operate as a generator to convert mechanical energy of the wheel into electrical energy. In a variant of this aspect, the method further comprises storing the electrical energy in the battery. In another aspect, causing the hydraulic system to apply an increased friction braking torque includes commanding, by a controller, a hydraulic pressure generator and evacuator of the hydraulic system to increase the friction braking torque by an amount corresponding to the increased friction braking torque. In a variant of this aspect, the hydraulic pressure generator and evacuator is an ABS modulator of the hydraulic system. In a variant of this aspect, the hydraulic pressure generator and evacuator is a pressure booster of the hydraulic system.

In yet another embodiment the present disclosure provides a method for providing a braking torque to a wheel of an electric motorcycle. The method includes detecting an input received at a rear brake control of the motorcycle, where the input represents a brake torque demand. The method further includes determining a rear brake torque required to meet the brake torque demand, and calculating, based on a status of a battery of an electrical system of the motorcycle, an available regenerative torque. The method additionally includes responding to the available regenerative torque being sufficient to provide the rear brake torque by causing the electrical system to apply a first regenerative torque to the wheel in an amount corresponding to the rear brake torque and causing a hydraulic system of motorcycle to bleed hydraulic pressure to a rear friction brake of the motorcycle.

In one aspect of this embodiment, the method further comprises responding to the available regenerative torque being insufficient to provide the rear brake torque by causing the electrical system to apply a second regenerative torque to the wheel in an amount corresponding to the available regenerative torque and causing the hydraulic system to decrease hydraulic pressure to the rear friction brake by an amount corresponding to a difference between the rear brake torque and the second regenerative torque. In another aspect, detecting an input includes sensing a force applied to the rear brake control using a pressure sensor configured to sense a change in hydraulic pressure corresponding to the force applied to the rear brake control, the sensed hydraulic pressure corresponding to the brake torque demand. In a variant of this aspect, detecting an input includes providing, by the pressure sensor, at least one measurement of the hydraulic pressure to a controller in communication with the pressure sensor. In a further variant, determining the rear brake torque includes determining, by a controller based on the sensed hydraulic pressure, a torque corresponding to a torque available from the hydraulic system. In another aspect, the available regenerative torque is a maximum available regenerative torque. In another aspect, determining the available regenerative torque includes receiving, by a controller, from a battery management system of a battery pack of the electrical system, a charging current capacity of the battery. In another aspect, causing the electrical system to apply the first regenerative torque to the wheel includes commanding, by a controller, a motor controller to cause an electric machine mechanically coupled to the wheel to operate as a generator to convert mechanical energy of the wheel into electrical energy. In a variant of this aspect, the method further comprises storing the electrical energy in the battery. In another aspect, causing the electrical system to apply the second regenerative torque to the wheel includes commanding, by a controller, a motor controller to cause an electric machine mechanically coupled to the wheel to operate as a generator to convert mechanical energy of the wheel into electrical energy. In a variant of this aspect, the method further comprises storing the electrical energy in the battery. In another aspect, causing the hydraulic system to decrease hydraulic pressure to the rear friction brake includes commanding, by a controller, a hydraulic pressure generator and evacuator of the hydraulic system to bleed hydraulic pressure to the rear friction brake. In a variant of this aspect, the hydraulic pressure generator and evacuator is an ABS modulator of the hydraulic system. In a variant of this aspect, the hydraulic pressure generator and evacuator is a pressure booster of the hydraulic system.

In still another embodiment the present disclosure provides a method for providing a braking torque to a wheel of an electric motorcycle. The method includes detecting an input received at a front brake control of the motorcycle and determining a front friction braking torque to apply to a front wheel of the motorcycle based on detecting the input. The method further includes determining a combined braking system (CBS) rear brake torque associated with the front friction braking torque, where the CBS rear brake torque determined to be applied to a rear wheel of the motorcycle. The method additionally includes calculating, based on a status of a battery of an electrical system of the motorcycle, an available regenerative torque, and responding to the available regenerative torque being sufficient to provide the CBS rear brake torque by causing the electrical system to apply a first regenerative torque to the rear wheel in an amount corresponding to the CBS rear brake torque.

In one aspect of this embodiment, the method further comprises responding to the available regenerative torque being insufficient to provide the CBS rear brake torque by causing the electrical system to apply a second regenerative braking torque to the rear wheel in an amount corresponding to the available regenerative torque and causing the hydraulic system to apply a friction braking torque to the rear wheel in an amount corresponding to a difference between the CBS rear brake torque and the second regenerative braking torque. In another aspect, detecting an input includes sensing a force applied to the front brake control using a pressure sensor configured to sense a change in hydraulic pressure corresponding to the force applied to the front brake control. In a variant of this aspect, detecting an input includes providing, by the pressure sensor, at least one measurement of the sensed hydraulic pressure to a controller in communication with the pressure sensor. In another aspect, the available regenerative torque is a maximum available regenerative torque. In still another aspect, determining the available regenerative torque includes receiving, by a controller, from a battery management system of a battery pack of the electrical system, a charging current capacity of the battery. In another aspect, causing the electrical system to apply the first regenerative torque to the rear wheel includes commanding, by a controller, a motor controller to cause an electric machine mechanically coupled to the rear wheel to operate as a generator to convert mechanical energy of the rear wheel into electrical energy. In a variant of this aspect, the method further comprises storing the electrical energy in the battery. In another aspect, causing the electrical system to apply the second regenerative torque to the rear wheel includes commanding, by a controller, a motor controller to cause an electric machine mechanically coupled to the rear wheel to operate as a generator to convert mechanical energy of the rear wheel into electrical energy. A variant of this aspect further comprises storing the electrical energy in the battery. In another aspect, causing the hydraulic system to apply a friction braking torque includes commanding, by a controller, a hydraulic pressure generator and evacuator of the hydraulic system to apply hydraulic fluid to a rear friction brake coupled to the rear wheel at a pressure corresponding to the friction braking torque. In a variant of this aspect, the hydraulic pressure generator and evacuator is an ABS modulator of the hydraulic system. In a variant of this aspect, the hydraulic pressure generator and evacuator is a pressure booster of the hydraulic system.

### BRIEF DESCRIPTION OF THE DRAWINGS

The above-mentioned and other advantages and objects of this invention, and the manner of attaining them, will become more apparent, and the invention itself will be better understood, by reference to the following description of embodiments of the invention taken in conjunction with the accompanying drawings, wherein:

FIG. 1 is a block diagram of a braking system for a vehicle;

FIG. 2 is a flow chart of a process for integrating regenerative braking and friction braking on a vehicle according to one embodiment of the present disclosure;

FIG. 3 is a diagram depicting components of rear friction braking according to the teachings of the present disclosure;

FIG. 4 is a graph depicting an example of a process for integrating regenerative braking and friction braking on a vehicle;

FIG. 5 is a graph depicting another example of a process for integrating regenerative braking and friction braking on a vehicle;

FIG. 6 is a flow chart of a process for integrating regenerative braking and friction braking on a vehicle according to another embodiment of the present disclosure; and

FIG. 7 is a graph depicting an example of a process for integrating regenerative braking and friction braking on a vehicle;

FIG. 8 is a block diagram of another braking system for a vehicle; and

FIG. 9 is a flow chart of a process for integrating regenerative braking and friction braking on a vehicle according to another embodiment of the present disclosure.

Corresponding reference characters indicate corresponding parts throughout the several views. Although the drawings represent embodiments of the present disclosure, the drawings are not necessarily to scale, and certain features may be exaggerated or omitted in some of the drawings to better illustrate and explain the present disclosure.

### DETAILED DESCRIPTION

When an operator applies the brakes using standard controls on a conventional electrical motorcycle, the energy provided by the mechanical braking system is lost as heat in the friction brake. Also, while some conventional control strategies apply regenerative braking based on throttle input and vehicle speed, or an additional control input from the operator (e.g., a forward twist of the throttle grip), in these cases the operator must change their behaviour in comparison to operating a motorcycle with an internal combustion engine (“ICE”) to maximize the energy recovered by the regenerative braking. It is desirable to provide a control strategy that integrates regenerative braking with the mechanical braking system of an electric motorcycle, while not requiring a change in the operator's behaviour relative to operation of an ICE motorcycle. Integration of regenerative braking with mechanical braking not only increases the range of the electric motorcycle by capturing energy through regenerative braking, it also results in a reduction in the average load on the rear friction brake of the motorcycle, thereby extending the life of the rear friction brake and reducing the maintenance requirements.

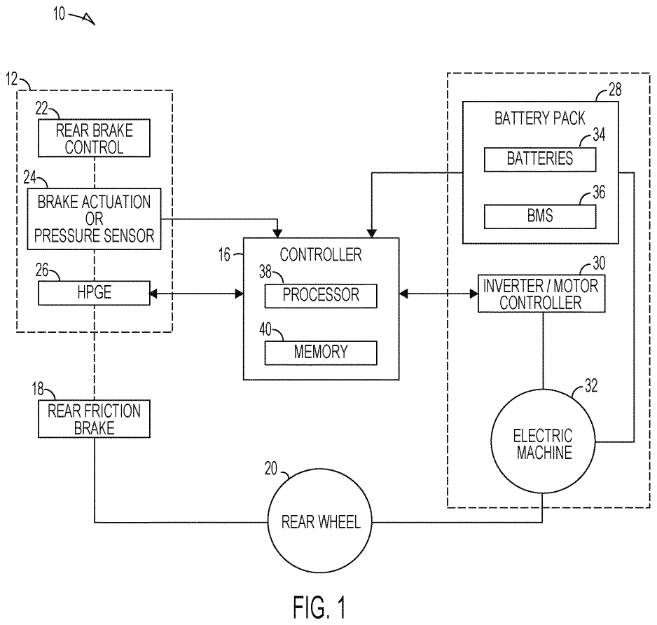

Referring now to FIG. 1, a braking system for integrating regenerative braking and rear friction braking on a vehicle is shown. While the braking system 10 is described herein as being used on an electric motorcycle, the principles of the present disclosure may be applied to other vehicles (e.g., motorized bicycles, three-wheelers, ATVs, etc.). It should also be understood that the principles of the present disclosure may be applied to front wheel braking and/or two axle braking, not just rear wheel braking as described below. The system 10 generally includes a hydraulic system 12, an electrical system 14, a controller 16, a rear friction brake 18 and a rear wheel 20. Of course, an electric motorcycle includes a plurality of other mechanical and electrical components (e.g., a frame, front wheel, seat, handlebars, lighting system, accessories, etc.).

The hydraulic system 12 generally includes a rear brake control 22, a brake actuation or pressure sensor 24 and a hydraulic pressure generator and evacuator (hereinafter, the “HPGE 26”). In certain embodiments, the HPGE 26 may be implemented as part of an anti-lock braking system (“ABS”) modulator. The rear brake control 22 is an electrically or mechanically actuated device (e.g., a brake pedal or a brake lever) on the vehicle used by the operator to control braking of the vehicle. As is known in the art, the amount of force the operator applies to the rear brake control 22 affects the amount of braking torque provided by the braking system 10. The rear brake control 22 is hydraulically connected to the brake actuation or pressure sensor 24. The brake actuation or pressure sensor 24 (hereinafter, the “brake pressure sensor 24”) detects or senses the actuation of the rear brake control 22 or the pressure in the hydraulic line connecting the rear brake control 22 to the brake pressure sensor 24. As described below, in certain embodiments, the actuation and amount of demanded friction braking may be detected without sensing the pressure in the hydraulic line(s). The amount of force the operator applies to the rear brake control 22 corresponds to the pressure in the hydraulic line (i.e., the higher the force, the higher the pressure) sensed by the brake pressure sensor 24. The HPGE 26 is hydraulically connected to the brake pressure sensor 24 and includes components for, among other things, controlling the hydraulic pressure of hydraulic fluid provided to the rear friction brake 18. The HPGE 26 may increase the pressure of the hydraulic fluid provided to the rear friction brake 18 or decrease or bleed the pressure of the hydraulic fluid based on the pressure sensed by the brake pressure sensor 4. The rear friction brake 18 is mechanically connected to the rear wheel 20. The rear friction brake 18 provides a braking torque to the rear wheel 20 in an amount corresponding to the hydraulic pressure provided by the hydraulic system 12.

In short, the hydraulic system 12 typically responds to the request for braking torque represented by the force the operator applies to the rear brake control 22 by providing hydraulic fluid to the rear friction brake 18 pressurized to a level corresponding to the requested braking torque. As described below, the control techniques of the present disclosure modify this mechanical braking technique by incorporating regenerative braking.

The electrical system 14 generally includes a battery pack 28, an inverter/motor controller 30 (hereinafter, the “motor controller 30”) and an electric machine 32 such as an electric motor. The battery pack 28 and the motor controller 30 are electrically connected to the electric machine 32. The battery pack 28 includes at least one rechargeable battery 34 and a battery management system (“BMS”) 36. The battery 34 stores energy used to power the electric machine 32 which in turn powers the rotation of the rear wheel 20 to cause the vehicle to move. The BMS 36 monitors operating parameters of the battery 34, such as the state-of-charge (“SOC”) of the battery 34 or the temperature of the battery pack 28. Based on these parameters, the BMS 36 determines the amount of additional charge current the battery 34 can safely accept at any time during operation of the vehicle. It should be understood, however, that other components (i.e., other than or in addition to the BMS 36) may be used to determine the available regenerative torque, T_{RM}. In an example, such components include electric powertrain controllers that measure motor speed, motor temperature, and/or motor derating strategy. The additional charge current of the battery 34 is referred to herein as the charge capacity of the battery 34. The motor controller 30 is configured to control the operation of the electric machine 32, which is mechanically connected to the rear wheel 20. For example, when acceleration is requested by the operator of the vehicle (e.g., by turning the throttle grip of the motorcycle), the motor controller 30 determines the amount of torque the electric machine 32 must provide to the rear wheel 20 to satisfy the acceleration request.

In an electric motorcycle, the electric machine 32 may provide both positive torque and negative torque to the rear wheel 20 of the motorcycle. As indicated above, the electric machine 32 provides positive torque to the rear wheel 20 to cause the vehicle to accelerate or to maintain the current speed of the vehicle. The electric machine 32 (under the control of the motor controller 30) may also apply a negative torque to the rear wheel 20 by operating in a braking mode, thereby causing the rear wheel 20 (and the vehicle) to decelerate or stop. In this regard, the electric machine 32 functions as a motor/generator wherein when operating as an electric motor, the electric machine 32 converts electrical power from the battery 34 to mechanical power (i.e., positive torque) provided to the rear wheel 20 and when operating in the braking mode as a generator, the electric machine 32 converts mechanical power from the rear wheel 20 (i.e., negative torque) to electrical power which may be provided to the battery pack 28 to recharge the battery 34 and extend the range of the vehicle.

The controller 16 of the system 10 interacts with components of the system 10 in the manner described below. The controller 16 includes at least one processor 38 and at least one memory device 40, along with other components the details of which are omitted from the description of the system 10. The controller 16 receives information (e.g., data or an electrical signal) from the brake pressure sensor 24 and the battery pack 28 and provides commands or control signals to the HPGE 26 and the motor controller 30. The functions of the controller 16 described herein may be performed by the processor 38 executing instructions stored in the memory device 40. It should be understood, however, that the functions of the controller 16 may be performed (or partially performed) by other components of the system 10, such as the HPGE 26, the BMS 36 and the motor controller 30. For simplicity, the following description assumes that the various functions of the controller 16 are performed by the processor 38 unless specified otherwise.

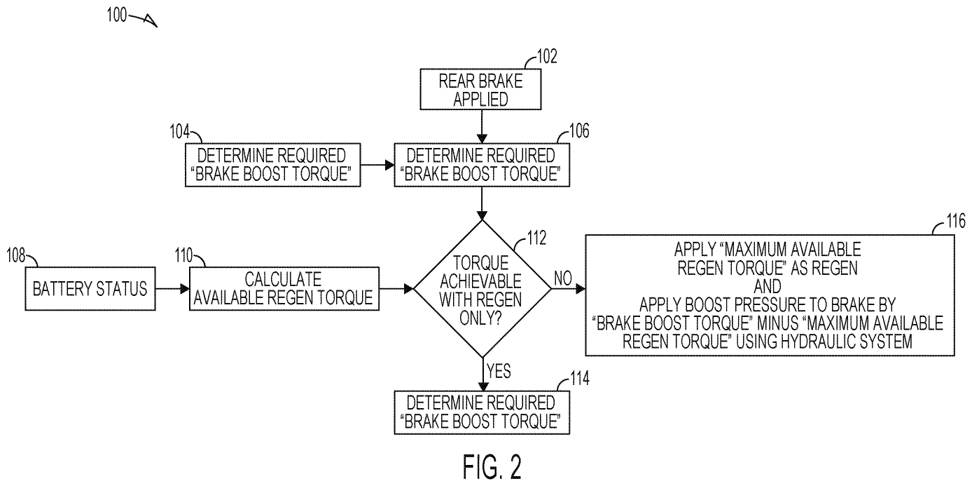

Referring now to FIG. 2, one embodiment of a process (e.g., a method or technique) for integrating regenerative braking and rear friction braking on an electric motorcycle is depicted in block diagram form. This embodiment, the brake boost process 100, generally involves using regenerative braking to the extent possible to satisfy at least a portion of the braking torque requested by the operator, while using friction braking to satisfy another portion of the braking torque if needed. In this embodiment, the hydraulic ratio used by the hydraulic system 12 may be undersized such that, for a given force applied to the rear brake control 22, a lower braking torque is applied to the rear wheel 20 by the rear friction brake 18 than would normally be applied in a system using conventional friction braking. For example, if the system 12 ordinarily would use a 12 mm diameter master cylinder, an “undersized” system 12 may use a 14 mm diameter master cylinder such that the force applied to the rear brake control 22 results in less force at the caliper pistons of the rear fiction brake 18. This permits use of regenerative braking to augment the friction braking (when possible) to result in a total braking force that is equivalent to a system using conventional friction braking. This use of regenerative braking results in the generation of electrical power by the electric machine 32 which may be stored in the battery 34, thereby extending the range of the vehicle. Additionally, as part of the braking torque applied by the system 10 is regenerative braking torque, the friction torque applied by the rear friction brake 18 is reduced, leading to a longer operating life of the rear friction brake 18 and reduced maintenance.

As shown, the process 100 begins at block 102 when the operator activates the rear brake control 22. At block 104, the activation of the rear brake control 22 is sensed by the brake pressure sensor 24 in the manner indicated above, as is the pressure of the hydraulic fluid (e.g., in the master cylinder). In an example, the brake pressure sensor 24 provides signals corresponding to the measured hydraulic pressure to the processor 38. It should be understood, however, that in alternative embodiments the braking demand may be detected without sensing the pressure of the hydraulic fluid. For example, the braking demand may be sensed by detecting the travel of or force applied to the rear brake control 22 (e.g., a lever or pedal). At block 106, the processor 38 determines a brake boost torque required to satisfy the braking torque corresponding to the force the operator applied to the rear brake control 22 (e.g., the pressure measured by the brake pressure sensor 24). In certain embodiments, the processor 38 accesses a look-up table stored in the memory device 40 to determine the brake boost torque required given the pressure measured by the brake pressure sensor 24.

The amount of brake boost torque determined by the processor 38 at block 106 may correspond to a percentage, fraction or other function, of the total torque needed to satisfy the braking demand. In an example, the determined brake boost torque corresponds to a percentage of the total torque that maximizes the amount of electrical power recovered by the electric machine 32 for storage in the battery 34. In another example, the determined brake boost torque corresponds to a percentage of the total torque that results in an experience for the operator that is intuitive for operators accustomed to all hydraulic braking, and/or that minimizes braking pulsations felt by the operator as a result of additional torque applied by the hydraulic system 12. The amount of brake boost torque determined by the processor 38 and its relationship to the total torque needed to satisfy the braking demand is further described below.

At block 108, the BMS 36 provides an indication of the battery status (e.g., the SOC of the battery 34, the temperature of the battery pack 28, etc.) to the controller 16. At block 110, the processor 38 determines, from the battery status, the available regeneration torque (i.e., the maximum amount of available regenerative torque) that can be applied by the electric machine 32 to the rear wheel 20. In an example, the available regeneration torque corresponds to the amount of charge current (e.g., a maximum amount of charge current) the battery 34 can receive for recharging the battery 34 given the current status of the battery 34 (i.e., the charge capacity of the battery 34 as described above).

At block 112, the processor 38 determines whether the available regeneration torque is sufficient to provide the brake boost torque determined at block 106. If the available regeneration torque is sufficient, then at block 114 the processor 38 commands the motor controller 30 to cause the electric machine 32 to operate as a generator and apply a negative torque to the rear wheel 20 in an amount corresponding to the brake boost torque. If, on the other hand, the available regeneration torque is not sufficient to provide the brake boost torque determined at block 106, then at block 116 the processor 38 commands the motor controller 30 to cause the electric machine 32 to operate as a generator and apply a negative torque to the rear wheel 20 in an amount corresponding to the maximum available regeneration torque. Additionally, at block 116, the processor 38 commands the HPGE 26 of the hydraulic system 12 to increase or boost the hydraulic pressure provided to the rear friction brake 18 in an amount corresponding to the brake boost torque minus the available regenerative torque. In other words, the processor 38 commands the electrical system 14 to provide as much of the brake boost torque as possible and commands the hydraulic system 12 to supply the additional torque needed. It should be understood that locking of the rear wheel 20 may be avoided using, for example, a combination of anti-lock braking and drag torque control systems to limit the applied hydraulic torque and the regeneration torque, respectively.

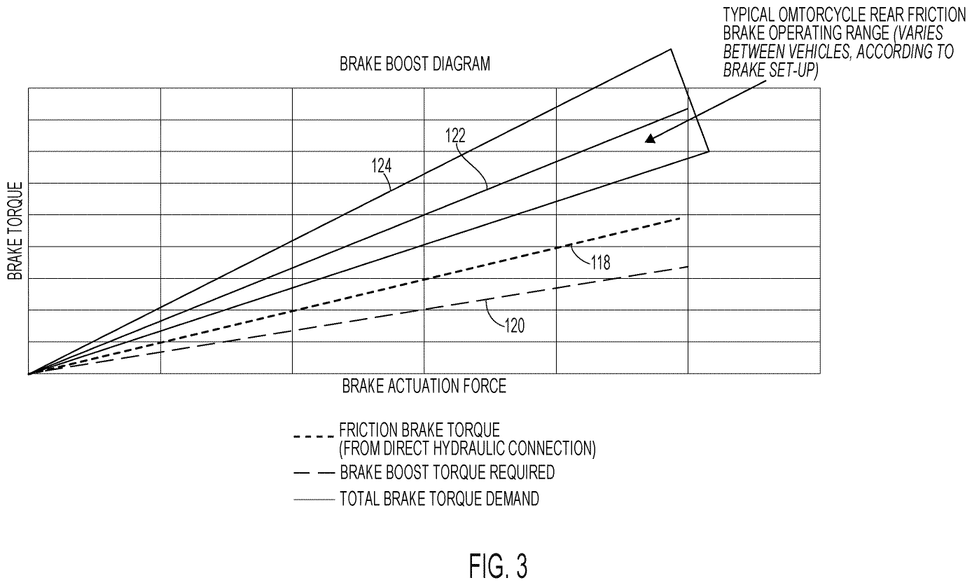

Referring now to FIG. 3, a brake boost diagram is provided depicting brake torque vs. brake actuation force. The y-axis is the brake torque of the rear friction brake of the vehicle. The x-axis is the brake actuation force applied by the vehicle operator to the rear brake control 22. The line 118 represents the friction brake torque generated by the hydraulic system 12 over the range of brake actuation forces shown. The line 120 represents the brake boost torque provided by the electrical system 14 over the range of brake actuation forces shown. The line 122 represents the total brake torque demand which is the sum of the friction brake torque 118 and the brake boost torque 120. The area 124 represents a typical vehicle rear friction brake operating range wherein the total brake torque demand may vary depending upon the brake set-up for the vehicle. As shown, as the operator applies greater brake actuation force to the rear brake control 22, the amount of total brake torque 122 demanded for the rear wheel of the vehicle increases and is satisfied by combinations of larger friction brake torque 118 amounts supplied by the hydraulic system 12 and larger brake boost torque 120 amounts supplied by the electrical system 14.

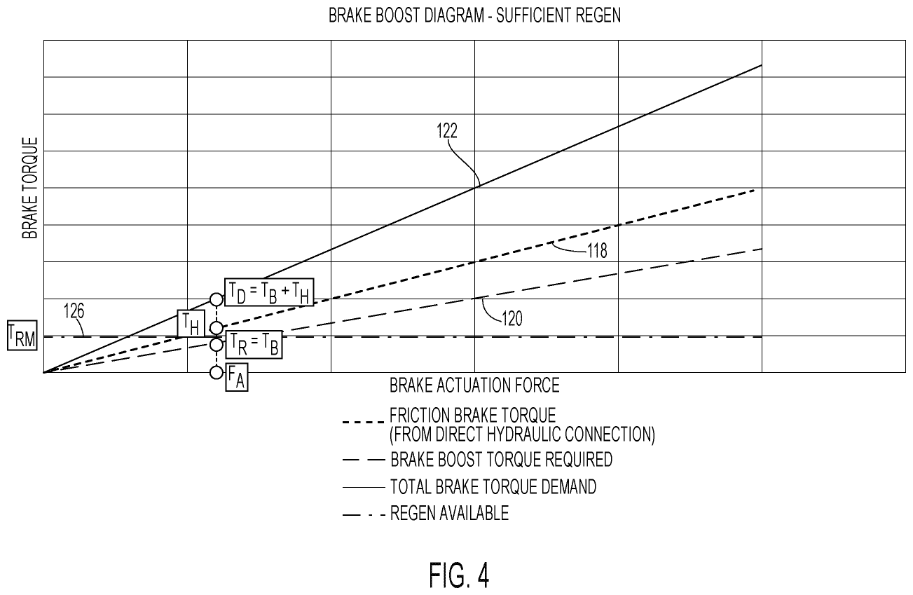

Referring now to FIG. 4, an example of a situation where the processor 38 determines at block 112 of FIG. 2 that the available regeneration torque is sufficient to provide the brake boost torque determined at block 106 of FIG. 2 is illustrated using the brake boost diagram of FIG. 3. In this example, a brake actuation force of F_{A} is applied by the vehicle operator to the rear brake control 22. The line 126 represents the available regeneration torque T_{RM} determined as described above. The torque corresponding to the brake actuation force F_{A} the operator applied to the rear brake control 22 is the torque demand T_{D} determined by the processor 38 based, for example, on the pressure measurements from the brake pressure sensor 24. In this embodiment, the torque demand T_{D} will always be greater than the torque available from the hydraulic system 12 using the undersized hydraulic torque ratio (shown as the hydraulic torque T_{H}). Thus, by definition, the torque demand T_{D} equals the hydraulic torque T_{H} plus the brake boost torque T_{B}. As such, the brake boost torque T_{B} needed to supplement the hydraulic torque T_{H} is the difference between the torque demand T_{D} and the hydraulic torque T_{H}. In this example, the available regenerative torque T_{RM} determined by the processor 38 based on the battery status from the BMS 36 and/or other components is more than sufficient to provide the entire brake boost torque T_{B}, so only a regenerative torque T_{R} in an amount corresponding to the brake boost torque T_{B} is applied to the rear wheel 20 and no additional torque is needed from the hydraulic system 12. The combination of the hydraulic torque T_{H} and the brake boost torque T_{B} (which in this case is the regenerative torque T_{R}) equals the total torque needed to satisfy the torque demand T_{D}.

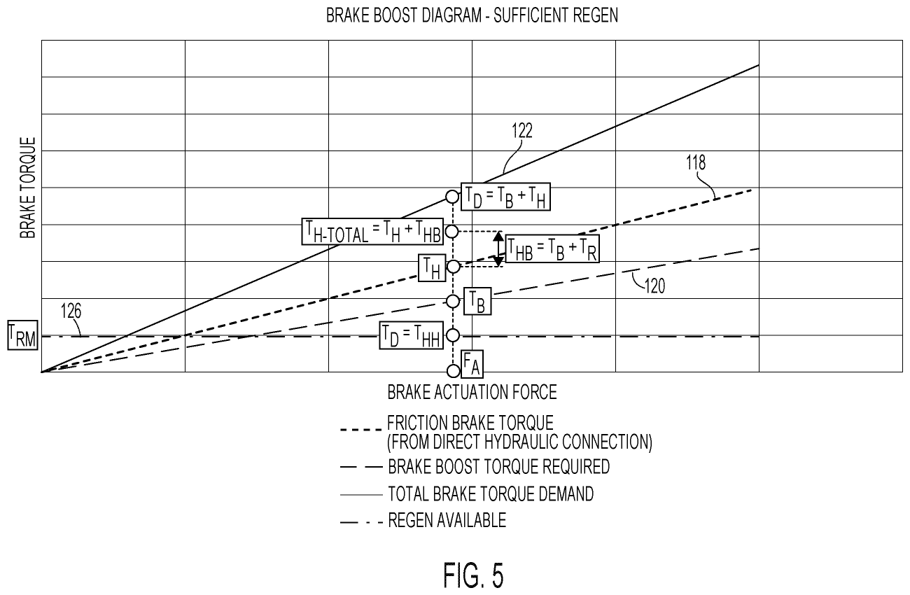

In the example depicted in FIG. 5, on the other hand, while the hydraulic torque T_{H} available using the undersized hydraulic torque ratio and the available regenerative torque T_{RM} are the same as in FIG. 4, since the torque demand T_{D} is higher (as a result of a higher braking force F_{A}), the available regenerative torque T_{RM} is insufficient to provide the entire brake boost torque T_{B} as determined by the processor 38 at block 112 of FIG. 2. Thus, as described above with reference to block 116 of FIG. 2, the available regenerative torque T_{RM} is applied to the rear wheel 20 as the regenerative torque T_{R}, along with the hydraulic torque T_{H} and an additional hydraulic boost torque T_{HB} (achieved from pressure build up by the HPGE 26) applied to the rear friction brake 18. The total brake torque T_{H-Total} from the hydraulic system 12 is the sum of the hydraulic torque T_{H} (resulting from the brake actuation force F_{A} applied by the operator) and the hydraulic boost torque T_{HB} (the difference between the brake boost torque T_{B} and the regenerative torque T_{R}, which in this case is available regenerative torque T_{RM}). The combination of the total brake torque T_{H-Total} and the regenerative torque T_{R} satisfies the torque demand T_{D}.

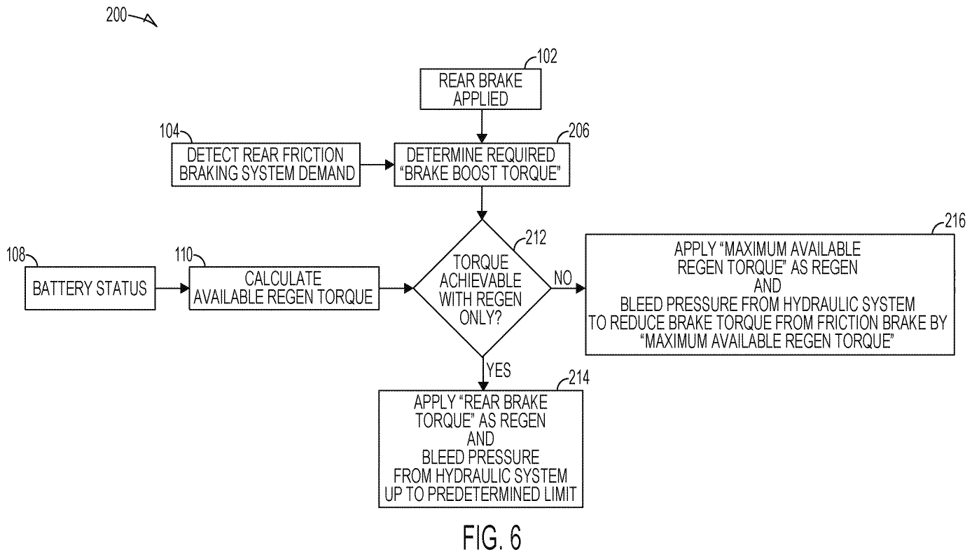

Referring now to FIG. 6, another embodiment of a process for integrating regenerative braking and rear friction braking on an electric motorcycle is depicted in block diagram form. This embodiment, the hydraulic pressure reduction process 200, generally includes using regenerative braking to satisfy at least a portion of the braking torque demanded by the operator and reducing the friction braking torque by an amount corresponding to the applied regenerative braking torque. Several of the blocks in FIG. 6 are the same as corresponding blocks in FIG. 2 and retain the same reference numerals. The blocks that are different from those in FIG. 2 have reference numerals that are incremented by 100. As shown, the process 200 begins at block 102 when the operator activates the rear brake control 22. At block 104, the activation of the rear brake control 22 is detected or sensed using, for example, the brake pressure sensor 24 in the manner indicated above, and the braking demand is determined from, for example, the pressure of the hydraulic fluid (e.g., in the master cylinder) or one of the other techniques described above. In an example, the brake pressure sensor 24 provides signals corresponding to the measured hydraulic pressure to the processor 38. At block 206, the processor 38 determines a rear brake torque required to satisfy the braking torque corresponding to the force the operator applied to the rear brake control 22 (i.e., the pressure measured by the brake pressure sensor 24). In certain embodiments, the processor 38 accesses a look-up table stored in the memory device 40 to determine the rear brake torque required given the pressure measured by the brake pressure sensor 24. In the embodiment represented by the hydraulic pressure reduction process 200, a standard hydraulic ratio is used by the hydraulic system 12 such that, for a given force applied to the rear brake control 22, the braking torque applied to the rear wheel 20 by the rear friction brake 18 is calculated to satisfy the entire torque demand from the operator. As explained below, if regenerative braking torque is available, it is used and the torque applied by the hydraulic system 12 is reduced from the calculated torque by an amount equal to the regenerative braking torque. This permits use of regenerative braking to replace a portion of the friction braking (when possible) to result in a total braking torque that would be equivalent to a system using friction braking alone. This use of regenerative braking results in the generation of electrical power by the electric machine 32 which may be stored in the battery 34, thereby extending the range of the vehicle.

At block 108, the BMS 36 provides an indication of the battery status (i.e., the SOC of the battery 34, the temperature of the battery pack 28, etc.) to the controller 16. At block 110, the processor 38 determines from the battery status the available regeneration torque that can be applied by the electric machine 32 to the rear wheel 20. The available regeneration torque corresponds to the maximum amount of charge current the battery 34 can receive for recharging the battery 34 given the current status of the battery 34 (i.e., the charge capacity of the battery 34 as described above).

At block 212, the processor 38 determines whether the available regeneration torque is sufficient to provide the rear brake torque determined at block 206. If so, then at block 214 the processor 38 commands the motor controller 30 to cause the electric machine 32 to operate as a generator and apply a negative torque to the rear wheel 20 in an amount corresponding to the rear brake torque. The processor 38 further commands the HPGE 26 of the hydraulic system 12 to decrease or bleed the hydraulic pressure provided to the rear friction brake 18 by an amount up to a predetermined limit. In some embodiments, the predetermined limit may be all the hydraulic pressure such that the friction braking is reduced to zero and replaced entirely by the regenerative braking. In other embodiments, the predetermined limit may be less than all the hydraulic pressure.

If, on the other hand, the available regeneration torque is not sufficient to provide the rear brake torque determined at block 206, then at block 216 the processor 38 commands the motor controller 30 to cause the electric machine 32 to operate as a generator and apply a negative torque to the rear wheel 20 in an amount corresponding to the available regeneration torque. Additionally, at block 216, the processor 38 commands the HPGE 26 of the hydraulic system 12 to decrease or bleed the hydraulic pressure provided to the rear friction brake 18 in an amount corresponding to the rear brake torque minus the available regenerative torque. In other words, the processor 38 commands the electrical system 14 to provide as much of the rear brake torque as possible and commands the hydraulic system 12 to reduce the friction torque that would normally be applied to the rear wheel 20 by an amount corresponding to the torque provided by the electrical system 14. It should be understood that locking of the rear wheel 20 may be avoided using, for example, a combination of anti-lock braking and drag torque control systems to limit the applied hydraulic friction and the regeneration torque, respectively.

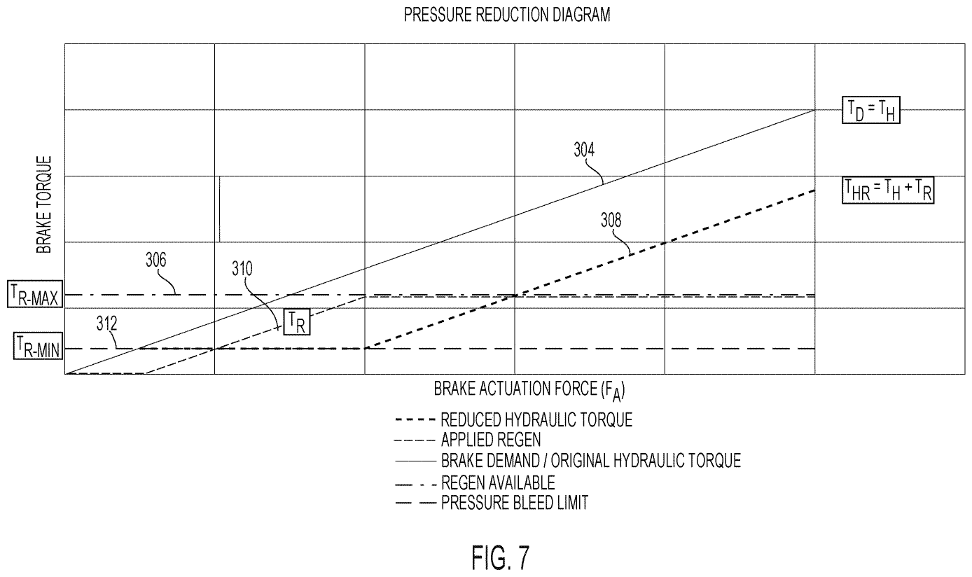

Referring now to FIG. 7, a graph is provided to illustrate the operation of the hydraulic pressure reduction process 200 described above. In the example depicted in FIG. 7, the line 304 represents the hydraulic torque available from the hydraulic system 12 using a standard torque ratio. As the hydraulic system, in this embodiment, uses a torque ratio sized to satisfy the torque demand T_{D}, the line 304 also represents the torque demand T_{D} (i.e., the brake torque corresponding to the actuation force F_{A} applied by the operator to the rear brake control 22). In the process 200, the torque demand T_{D} corresponds to the rear brake torque determined by the processor 38 at block 206 of FIG. 6. Normally, the hydraulic system 12 would apply a hydraulic torque T_{H} corresponding to the torque demand T_{D}. In this embodiment, however, the processor 38 causes the hydraulic system 12 to bleed the hydraulic pressure to the rear friction brake 18 to provide the applied hydraulic torque (T_{HR}) to permit use of the available regenerative torque T_{R-MAX} (line 306) along with the reduced hydraulic torque T_{HR} (line 308) to meet the torque demand T_{D}. As shown in the first two segments of the brake actuation force F_{A} in FIG. 7 (i.e., lower actuation forces F_{A}), the applied hydraulic torque T_{HR} may be reduced to a minimum hydraulic torque T_{H-MIN} (line 312) when the combination of the applied regeneration torque T_{R} (line 310) and the minimum hydraulic torque T_{H-MIN} is sufficient to satisfy the torque demand T_{D}. For higher torque demands T_{D} (i.e., higher actuation forces F_{A}), the reduced hydraulic torque T_{HR} is reduced such that the combination of the reduced hydraulic torque T_{HR} and the available regenerative torque T_{R-MAX} is sufficient to satisfy the torque demand T_{D}.

As should be understood from the foregoing, the amount of regenerative braking torque used in the hydraulic pressure reduction process 200 may be greater than the amount of regenerative braking torque used in the brake boost process 100. In the brake boost process 100, the maximum amount of regenerative braking torque T_{R} is an amount corresponding to the brake boost torque T_{B}. In the hydraulic pressure reduction process 200, on the other hand, the maximum amount of regenerative braking torque T_{R} could be an amount corresponding to the entire torque demand T_{D}, as depicted in FIG. 7. As such, the hydraulic pressure reduction process 200 may capture and store a greater amount of energy to extend the range of the vehicle.

It should also be understood that while the embodiments of the present disclosure are described separately above, it is contemplated that the methods could be implemented together on a vehicle. For example, the hydraulic pressure reduction process 200 could be applied to the hydraulic braking torque T_{H} portion of the braking force in the brake boost process 100. In such an example, as compared to the hydraulic pressure reduction process 200 described above, less pressure would need to be bled off by the HPGE 26, which may improve the feel of the braking system. Additionally, as compared to the brake boost process 100 described above, an increased amount of energy may be recovered for extending the range of the vehicle.

As should be apparent from the foregoing, after a vehicle is set up for the brake boost process 100 by implementing an undersized hydraulic ratio using a particular physical sizing of the master cylinder and caliper pistons, the brake boost process 100 will be used for braking in all circumstances unless the vehicle is physically reconfigured. The hydraulic pressure reduction process 200, on the other hand, may be activated or deactivated electronically.

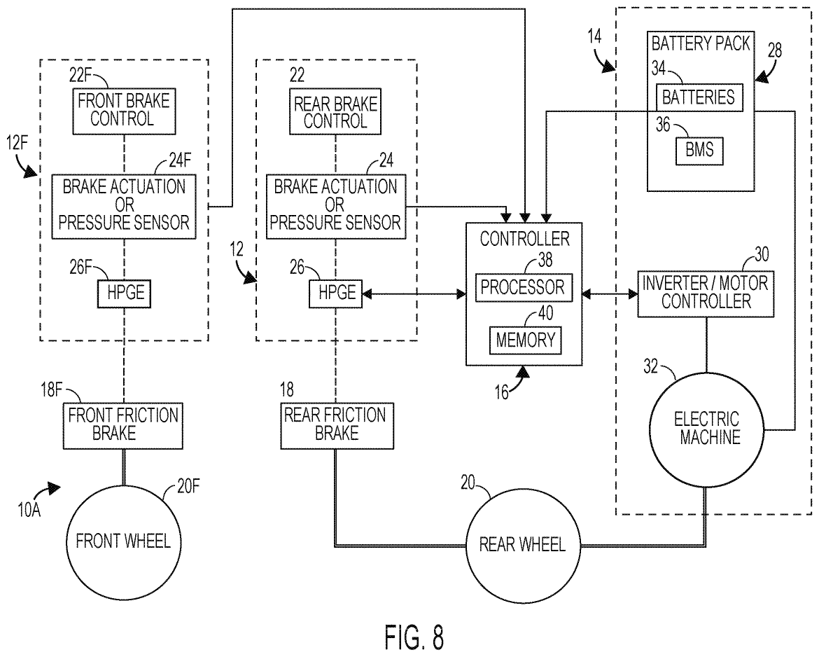

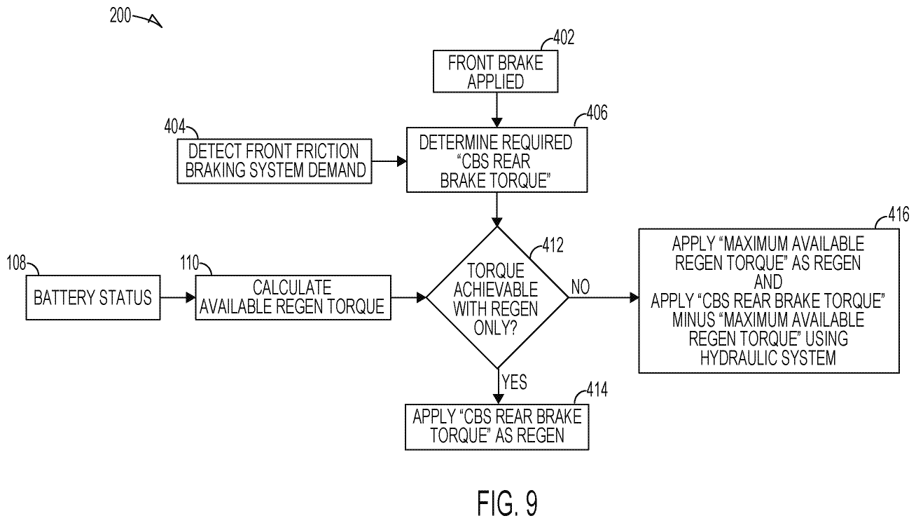

Referring now to FIG. 8, a braking system 10F for integrating regenerative braking and combined friction braking on an electric vehicle is shown. The system 10F is the same as the system 10 of FIG. 1 except that a second hydraulic system 12F is included for actuating a front friction brake 18F to apply braking force to a front wheel 20F of the vehicle. The hydraulic system 12F includes a front brake control 22F (e.g., a front brake lever), a pressure sensor 24F and an HPGE 26F which are connected together in the manner described above with reference to hydraulic system 12. The pressure sensor 24F is connected to the controller 16. In FIG. 9, a process for integrating regenerative braking in the combined friction braking system 10F of FIG. 8 on an electric motorcycle is depicted in block diagram form.

This embodiment, the combined braking process 400, generally includes using regenerative braking to supply at least a portion of supplemental torque applied to the rear friction brake 18 when the vehicle operator operates the front brake control 22F. In some combined braking systems having independent brake controls for the front friction brake 18F associated with the front wheel 20F of the vehicle and for the rear friction brake 18 associated with the rear wheel 20 of the vehicle, when the operator of the vehicle actuates the front brake control 22F, the hydraulic system 12F applies torque corresponding to the demand associated with actuation of the front brake control 22F (e.g., as sensed by the pressure sensor 24F) to the front friction brake 18F mechanically coupled to the front wheel 18F of the vehicle. The ABS modulator or a pressure booster may also apply a supplemental torque to the rear friction brake 18 to balance the braking torque.

Combined braking may also be used to actually reduce the torque applied to the front friction brake 18F (i.e., below the torque demand associated with the pressure applied to the front brake control 22F) and apply even more supplemental torque to the rear friction brake 18. Combined braking may also be used to apply supplemental torque to the front friction brake 18F when the operator actuates the rear brake control 22. In each of these examples, the systems 10A already include electronic control of the front friction brake 18F and the rear friction brake 18 for combined braking. They do not, however, incorporate regenerative braking.

The combined braking process 400 of FIG. 9 provides both combined braking and integrated regenerative braking. Two of the blocks in FIG. 9 are the same as corresponding blocks in FIG. 2 and retain the same reference numerals. The blocks that are different from those in FIG. 2 have reference numerals that are incremented by 300. As shown, the process 400 begins at block 402 when the operator activates the front brake control 22F. At block 404, the activation of the front brake control 22F is sensed using, for example, the brake pressure sensor 24F in the manner indicated above. The processor 38 determines the front braking demand from the pressure sensed by the brake pressure sensor 24F as well as the required combined braking system (CBS) rear brake torque as indicated at block 406. In certain embodiments, the processor 38 accesses a look-up table stored in the memory device 40 to determine the CBS rear brake torque required given the pressure measured by the brake pressure sensor 24F.

At block 108, the BMS 36 provides an indication of the battery status (i.e., the SOC of the battery 34, the temperature of the battery pack 28, etc.) to the controller 16. At block 110, the processor 38 determines from the battery status the available regeneration torque that can be applied by the electric machine 32 to the rear wheel 20. As explained above, the available regeneration torque corresponds to the maximum amount of charge current the battery 34 can receive for recharging the battery 34 given the current status of the battery 34.

At block 412, the processor 38 determines whether the available regeneration torque is sufficient to provide the CBS rear brake torque determined at block 406. If so, then at block 414 the processor 38 commands the motor controller 30 to cause the electric machine 32 to operate as a generator and apply a negative torque to the rear wheel 20 in an amount corresponding to the CBS rear brake torque.

If, on the other hand, the available regeneration torque is not sufficient to provide the CBS rear brake torque determined at block 406, then at block 416 the processor 38 commands the motor controller 30 to cause the electric machine 32 to operate as a generator and apply a negative torque to the rear wheel 20 in an amount corresponding to the maximum available regeneration torque. Additionally, at block 416, the processor 38 commands the HPGE 26 of the hydraulic system 12 to apply hydraulic pressure to the rear friction brake 18 in an amount corresponding to the CBS rear brake torque minus the maximum available regeneration torque. In other words, the processor 38 commands the electrical system 14 to provide as much of the CBS rear brake torque as possible and commands the hydraulic system 12 to supply the rest.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A system for providing a braking torque to a wheel of an electric motorcycle, comprising:
a hydraulic system hydraulically coupled to a friction brake of the motorcycle, the friction brake being mechanically coupled to the wheel and configured to decrease the a rotation speed of the wheel in response to a pressure of hydraulic fluid provided to the friction brake by the hydraulic system;
an electrical system mechanically coupled to the wheel; and
a controller coupled to the hydraulic system and the electrical system;
wherein the hydraulic system includes a sensor configured to detect an input received at a brake control of the hydraulic system, the input corresponding to a brake torque demand;
wherein the controller is configured to:
calculate, based on a status of a battery of the electrical system, an available regenerative braking torque available from the electrical system;
determine a brake boost torque, the brake boost torque including a torque to provide in addition to a friction braking torque of the hydraulic system, to meet the brake torque demand; and
respond to the available regenerative braking torque being sufficient to provide the brake boost torque by causing the electrical system to apply a first regenerative torque to the wheel in an amount corresponding to the brake boost torque.

2. The system of claim 1, wherein the controller is configured to respond to the available regenerative torque being insufficient to provide the brake boost torque by causing the electrical system to apply a second regenerative braking torque to the wheel in an amount corresponding to the available regenerative torque and causing the hydraulic system to apply an increased friction braking torque, in addition to the friction braking torque, in an amount corresponding to a difference between the brake boost torque and the second regenerative braking torque.

3. The system of claim 1, wherein the input is a force applied to the brake control and the sensor is a pressure sensor configured to sense a change in hydraulic pressure corresponding to the force applied to the brake control, the sensed hydraulic pressure corresponding to the brake torque demand.

4. The system of claim 3, wherein the controller is configured to determine the brake boost torque based on the sensed hydraulic pressure, by determining a difference between the brake torque demand and a friction braking torque available from the hydraulic system.

5. The system of claim 1, wherein the available regenerative braking torque is a maximum available braking torque.

6. The system of claim 1, wherein the electrical system includes a battery pack communicatively coupled to the controller, the battery pack including the battery and a battery management system configured to provide the controller the status of the battery including a charging current capacity of the battery.

7. The system of claim 1, wherein the controller is configured to cause the electrical system to apply the first regenerative torque to the wheel by commanding a motor controller of the electrical system to cause an electric machine mechanically coupled to the wheel to operate as a generator to convert mechanical energy of the wheel into electrical energy.

8. The system of claim 2, wherein the controller is configured to cause the hydraulic system to apply the increased friction braking torque by commanding a hydraulic pressure generator and evacuator of the hydraulic system to increase the friction braking torque by an amount corresponding to the increased friction braking torque.

9. The system of claim 8, wherein the hydraulic pressure generator and evacuator is an ABS modulator of the hydraulic system.

10. The system of claim 8, wherein the hydraulic pressure generator and evacuator is a pressure booster of the hydraulic system.

11. A method for providing a braking torque to a wheel of an electric motorcycle, comprising:
detecting an input received at a brake control of the motorcycle, the input representing a brake torque demand;
determining a brake boost torque, the brake boost torque including a torque to provide in addition to a friction braking torque of a hydraulic system of the motorcycle, to meet the brake torque demand;
calculating, based on a status of a battery of an electrical system of the motorcycle, an available regenerative torque; and
responding to the available regenerative torque being sufficient to provide the brake boost torque by causing the electrical system to apply a first regenerative torque to the wheel in an amount corresponding to the brake boost torque.

12. The method of claim 11, further comprising responding to the available regenerative torque being insufficient to provide the brake boost torque by causing the electrical system to apply a second regenerative braking torque to the wheel in an amount corresponding to the available regenerative torque and causing the hydraulic system to apply an increased friction braking torque, in addition to the friction braking torque, in an amount corresponding to a difference between the brake boost torque and the second regenerative braking torque.

13. The method of claim 11, wherein detecting an input includes detecting a force applied to the brake control using a pressure sensor configured to sense a change in hydraulic pressure corresponding to the force applied to the rear brake control, the sensed hydraulic pressure corresponding to the brake torque demand.

14. The method of claim 11, wherein the available regenerative torque is a maximum available regenerative torque.

15. The method of claim 11, wherein determining the available regenerative braking torque includes receiving, by a controller, from a battery management system of a battery pack of the electrical system, a charging current capacity of the battery.

16. The method of claim 11, wherein causing the electrical system to apply the first regenerative torque to the wheel includes commanding, by a controller, a motor controller to cause an electric machine mechanically coupled to the wheel to operate as a generator to convert mechanical energy of the wheel into electrical energy.

17. A method for providing a braking torque to a wheel of an electric motorcycle, comprising:
detecting an input at a rear brake control of the motorcycle, the input representing a brake torque demand;
determining a rear brake torque required to meet the brake torque demand;
calculating, based on a status of a battery of an electrical system of the motorcycle, an available regenerative torque; and
responding to the available regenerative torque being sufficient to provide the rear brake torque by causing the electrical system to apply a first regenerative torque to the wheel in an amount corresponding to the rear brake torque and causing a hydraulic system of motorcycle to bleed hydraulic pressure to a rear friction brake of the motorcycle.

18. The method of claim 17, further comprising responding to the available regenerative torque being insufficient to provide the rear brake torque by causing the electrical system to apply a second regenerative torque to the wheel in an amount corresponding to the available regenerative torque and causing the hydraulic system to decrease hydraulic pressure to the rear friction brake by an amount corresponding to a difference between the rear brake torque and the second regenerative torque.

19. The method of claim 17, wherein detecting an input includes sensing a force applied by an operator to the rear brake control using a pressure sensor configured to sense a change in hydraulic pressure corresponding to the force applied to the rear brake control, the sensed hydraulic pressure corresponding to the brake torque demand.

20. The method of claim 17, wherein determining the available regenerative torque includes receiving, by a controller, from a battery management system of a battery pack of the electrical system, a charging current capacity of the battery.
